(19) United States
(12) Patent Application Publication
(10) Pub. No.: US 2026/0058814 A1
(43) Pub. Date: Feb. 26, 2026

(54) RIGHTS BOUND TOKENS, AND ASSOCIATED METHODS, APPARATUS, AND ARTICLES

(71) Applicant: MINTANGIBLE, INC., Richmond, VA (US)

(72) Inventors: Amyli McDaniel, Richmond, VA (US); Nicole Bryan, Austin, TX (US)

(21) Appl. No.: 19/102,761

(22) PCT Filed: Aug. 22, 2023
(86) PCT No.: PCT/US2023/072630

§ 371 Date: Feb. 10, 2025

Related U.S. Application Data
(60) Provisional application No. 63/402,197, filed on Aug. 30, 2022.

(51) Int. Cl. H04L 9/32; H04L 9/00

(52) U.S. Cl. CPC H04L 9/3213; H04L 9/50

(57) ABSTRACT

A rights bound token (RBT) creation and management engine (C&ME) generates and manages RBTs, in a distributed, immutable, permanent, decentralized, verifiable, secure, permissionless, trustless form and/or evolvable. RBTs constitute a new asset class, and are digitally native, decentralized assets that evidence rights to other assets, employing blockchain technology using distributed ledgers and that are advantageously blockchain agnostic and enhance security. RBTs employ an on chain token and a rights package inextricably bound by at least one external binding. Rights packages are comprised of a rights manifest and a rights storage mechanism, selected from various rights manifests and rights storage mechanisms. Treating the token, rights package (rights manifests, rights storage) and bindings as distinct objects advantageously allows customization for various technical and non-technical criteria, and facilitates operation is across a wide range of different blockchain services, accommodating heterogeneous protocols, heterogeneous file types and even heterogeneous storage mechanisms.

### CROSS-REFERENCE TO RELATED APPLICATION

This patent application claims priority of U.S. Patent Application No. 63/402,197, filed on Aug. 30, 2022, the entire disclosure of which is hereby incorporated by reference herein for all purposes.

### FIELD

This disclosure generally relates to methods, apparatus, and articles that provide secure, immutable digital tokens, employing blockchain technology using distributed ledgers.

### BACKGROUND

### Description of the Related Art

Various uses of blockchain technology employing distribution ledgers have been proposed. In some implementations, fungible tokens are employed, for example as cryptocurrency to represent a monetary value, which are stored and verified on a blockchain, and which may or may not be exchangeable into conventional currency. In other implementations, non-fungible tokens (NFTs) are employed to represent a unique digital asset stored and verified on a blockchain. There are many different blockchain service providers, each having their own specific implementations, protocols, storage mechanisms, and often their own specific service charges (e.g., gas fee).

### BRIEF SUMMARY

This disclosure generally relates to methods, apparatus, and articles that associate a first on-chain object in the form of a token with a second object that may or may not be on-chain, via a binding object which is on chain, while addressing various technical issues to provide robustness and flexibility with respect to any one or more of: an order of instantiation, pre- and post-facto processing, and blockchain service selection, while allowing for evolution in a distributed, immutable, permanent, decentralized, verifiable, secure, permissionless, and/or trustless form. This disclosure more specifically relates to methods, apparatus, and articles that generate and manage rights bound tokens (RBTs). Rights bound tokens constitute a new asset class, and are digitally native, decentralized assets that evidence rights to other assets, employing blockchain technology using distributed ledgers and that are advantageously blockchain agnostic.

The ecosystem around nonfungible tokens (NFTs) is still in its infancy and thus there are many innovations, and even possibly necessities, around the creation and ongoing management of NFTs. One primary example of this is that many NFT creators do not want to actually mint the NFT until there is an active buyer wanting to purchase the NFT. This presents a technical chicken and egg situation. One wants rights to be instantiated at the time of creation of the NFT, but in order to do that one has to have created the rights ahead of the NFT creation. Because immutability and permanence is desired, the order of operations matters and must be handled appropriately in order to maintain immutability while allowing rights to be created ahead of the instantiation of the token. There is also post-facto processing that must be performed in a way that maintains the immutability and permanence but allows for evolution of the rights after instantiation of an RBT.

The methods, apparatus, and articles described herein employ a rights bound token creation and management engine (C&ME) to generate and manage RBTs. Such can provide RBTs in a distributed, immutable, permanent, decentralized, verifiable, secure, permissionless, and/or trustless form, advantageously enhancing security and verifiability over conventional approaches.

The methods, apparatus, and articles described herein advantageously allow operation across a wide range of different blockchain services, accommodating heterogeneous protocols, heterogeneous file types and even heterogeneous storage mechanisms. The methods, apparatus, and articles described herein advantageously provide a blockchain agnostic solution, and can even autonomously select between blockchain services, protocols, file types and even storage mechanisms based on various criteria.

The methods, apparatus, and articles advantageously provide for the evolution of rights associated to an RBT while maintaining enhanced security and verifiability. The methods, apparatus, and articles also advantageously provide for ongoing assent of rights as the RBT is transferred (e.g., bought or sold); ensuring point in time integrity of exactly what rights are associated to the RBT; and ensuring point in time integrity of exactly who has the rights.

The methods, apparatus, and articles also advantageously provide for ongoing monitoring, discoverability and notifications around RBTs and their associated rights.

A method can be summarized as: generating at least one rights package based on at least one set of criteria, the at least one rights package specifying at least one right that is based on the at least one set of criteria; selecting a binding type based on at least one set of criteria; instantiating an instance of a rights bound token comprising a tokenized asset on a blockchain inextricably bound to the at least one rights package.

The method can further include: selecting a rights protocol; selecting a rights manifest type; generating a rights manifest based at least in part on the selected rights manifest type; and selecting a rights storage type, wherein instantiating an instance of a rights bound token includes instantiating the instance of the rights bound token with the rights package comprising the rights manifest and the rights storage. The selected rights manifest type can allow the rights manifest to be stored in an immutable, distributed and permanent form.

Selecting a binding type can include selecting at least one external binding type, and instantiating an instance of a rights bound token comprising a tokenized asset on a blockchain inextricably bound to the at least one rights package includes instantiating the instance of the rights bound token with at least one on-chain external binding of the selected external binding type, the at least one on-chain external binding which binds the tokenized asset and the rights package. Selecting a binding type can further include selecting an internal binding type in addition to the selected at least one external binding type.

A system can be summarized as including: at least one processor; and at least one nontransitory processor-readable medium communicatively coupled to the at least one processor, the at least one nontransitory processor-readable medium which stores processor-executable instructions which, when executed by the at least one processor, cause the at least one processor to: generate at least one rights package based on at least one set of criteria, the at least one rights package specifying at least one right that is based on the at least one set of criteria; select a binding type based on at least one set of criteria; instantiate an instance of a rights bound token comprising a tokenized asset on a blockchain inextricably bound to the at least one rights package.

The processor-executable instructions, when executed by the at least one processor, can cause the at least one processor further to: select a rights protocol; selecting a rights manifest type; generate a rights manifest based at least in part on the selected rights manifest type; and select a rights storage type, wherein instantiation of an instance of a rights bound token includes instantiation of the instance of the rights bound token with the rights package comprising the rights manifest and the rights storage. The selected rights manifest type can allow the rights manifest to be stored in an immutable, distributed and permanent form.

A method can be summarized as: generating at least one rights package customized to a specific application or user; selecting a binding type to be used as a primary external binding; subsequent to the generating of the at least one rights package, instantiating an instance of a rights bound token comprising a tokenized asset on a blockchain inextricably bound to the at least one rights package via at least the primary external binding; and instantiating the at least one rights package on the same or a different blockchain from the tokenized asset as at least one immutable rights package either synchronously with a minting of the tokenized asset or following the minting of the tokenized asset.

The method can further include: detecting when the tokenized asset has been minted and wherein instantiating the at least one rights package on the same or a different blockchain from the tokenized asset as at least one immutable rights package is responsive to detection of the tokenized asset having been minted.

The method can further include: generating at least one new rights package after instantiating an instance of a rights bound token; and generating at least one new primary external binding that inextricably binds the at least one new rights package to the instance of the rights bound token. The at least one new rights package can include a new set of rights. The at least one new rights package can include an indication of an assent by a new owner to a set of existing rights set out in the at least one rights package that was inextricably bound with the tokenized asset via at least the primary external binding on the instantiation of the instance of a rights bound token.

A system can be summarized as including: at least one processor; and at least one nontransitory processor-readable medium communicatively coupled to the at least one processor, the at least one nontransitory processor-readable medium which stores processor-executable instructions which, when executed by the at least one processor, cause the at least one processor to: generate at least one rights package customized to a specific application or user; select a binding type to be used as a primary external binding; subsequent to or currently with or in conjunction with the generation of the at least one rights package, instantiate an instance of a rights bound token comprising a tokenized asset on a blockchain inextricably bound to the at least one rights package via at least the primary external binding; and instantiate the at least one rights package on the same or a different blockchain from the tokenized asset as at least one immutable rights package either synchronously with a minting of the tokenized asset or following the minting of the tokenized asset.

The processor-executable instructions, when executed by the at least one processor, can cause the at least one processor further to: detect when the tokenized asset has been minted and wherein instantiation of the at least one rights package on the same or a different blockchain from the tokenized asset as at least one immutable rights package is responsive to detection of the tokenized asset having been minted.

The processor-executable instructions, when executed by the at least one processor, can cause the at least one processor further to: generate at least one new rights package after instantiation of an instance of a rights bound token; and generate at least one new primary external binding that inextricably binds the at least one new rights package to the instance of the rights bound token. The at least one new rights package can include a new set of rights. The at least one new rights package can include an indication of an assent by a new owner to a set of existing rights set out in the at least one rights package that was inextricably bound with the tokenized asset via at least the primary external binding on the instantiation of the instance of a rights bound token.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of a rights bound token server system operated by a rights bound token service provider, which is networked to a plurality of blockchain server systems operated by respective blockchain service providers, each of the blockchain server systems networked with a plurality of processor-based systems (e.g., computer systems) which can form a distributed ledger and via which one or more blockchains can be established, according to at least one illustrated implementation.

FIG. 2 is a block diagram of an instance of a processor-based system according to at least one illustrated implementation, the rights bound token server system, the blockchain server systems, and/or the processor-based systems of FIG. 1 can each be implemented by a respective instance of the processor-based system depending on the processor-executable instructions executed by the processor(s) thereof.

FIG. 3 is a schematic diagram of a rights bound token including a number of constituent components thereof including an asset delivery token, one or more rights packages, and one or more rights bindings that bind the rights packages to the asset delivery token, according to at least one illustrated implementation.

FIG. 4 is a schematic diagram showing example combinations of manifests and storage mechanism that can be employed to form a rights package of a rights bound token, according to at least one illustrated implementation.

FIG. 5 is a schematic diagram showing an exemplary rights protocol meta-schema for use in generating and managing rights bound tokens, according to at least one illustrated implementation.

FIGS. 6A and 6B are a schematic diagram showing an example specification of a rights package with specified rights storage and rights manifest and an external binding for use with a rights bound token, according to at least one illustrated implementation.

FIG. 7 is a block diagram showing an exemplary of components of rights bound token creation and management engine (C&ME) operable to generate rights bound tokens, according to at least one illustrated implementation.

FIG. 8 is a block diagram showing a rights orchestrator operable to generate a rights bound token, according to at least one illustrated implementation.

FIG. 9 is a flow diagram showing a method of operation of a system to create and/or manage rights bound tokens, according to at least one illustrated implementation.

FIG. 10 is a flow diagram showing a method of operation of a system to create and/or manage rights bound tokens, according to at least one illustrated implementation.

FIG. 11 is a flow diagram showing a method of operation of a system to create and/or manage rights bound tokens, according to at least one illustrated implementation.

FIG. 12 is a flow diagram showing a method of operation of a system to create and/or manage rights bound tokens, according to at least one illustrated implementation.

FIG. 13 is a flow diagram showing a method of operation of a system to create and/or manage rights bound tokens, according to at least one illustrated implementation.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with processor-based systems (e.g., computer systems), networks, and distributed ledgers have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”Reference throughout this specification to “one implementation” or “an implementation” or to “one embodiment” or “an embodiment” means that a particular feature, structure or characteristic described in connection with the implementation or embodiment is included in at least one implementation or embodiment. Thus, the appearances of the phrases “in one implementation” or “in an implementation” or “in one embodiment” or “in an embodiment” in various places throughout this specification are not necessarily all referring to the same implementation or embodiment. Furthermore, the particular features, structures, or characteristics may be combined in any suitable manner in one or more implementations or embodiments.

As used in this specification and the appended claims, the singular forms “a,” “an,” and “the” include plural referents unless the content clearly dictates otherwise. It should also be noted that the term “or” is generally employed in its sense including “and/or”unless the content clearly dictates otherwise.

The headings and Abstract of the Disclosure provided herein are for convenience only and do not interpret the scope or meaning of the embodiments.

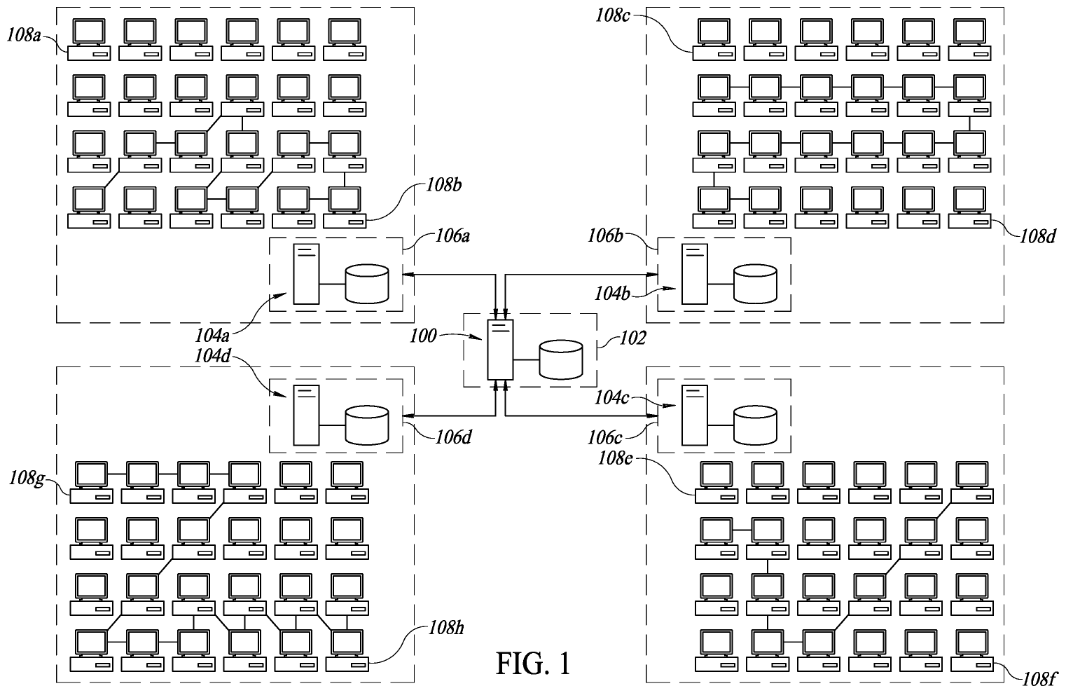

FIG. 1 shows a rights bound token server system 100 operated by a rights bound token service provider (indicated by broken line box) 102, according to at least one illustrated implementation.

The rights bound token server system 100 is illustrated as networked to a plurality of blockchain server systems 104a, 104b, 104c, 104d (four shown, collectively 104) operated by respective blockchain service providers (indicated by broken line boxes) 106a, 106b, 106c, 106d (four shown, collectively 106), respectively. Each of the blockchain server systems 106 is networked with a plurality of client processor-based systems (e.g., computer systems) 108a, 108b, 108c, 108d, 108e, 108f, 108g, 108h (ninety-six shown, only eight called out to avoid cluttering the drawing) to form a respective blockchain network (indicated by broken line boxes) 110a, 110b, 110c, 110d (four shown, collectively 110). The client processor-based systems 108 can form a distributed ledger, and via which one or more blockchains can be established. In FIG. 1, blockchains are indicated by sets of client processor-based systems 108 that are illustrated coupled by solid black lines between pairs of the client processor-based systems 108. Such is only for illustrative purposes, and any variety of blockchains employing distributed ledgers across a plurality of client processor-based devices can be employed.

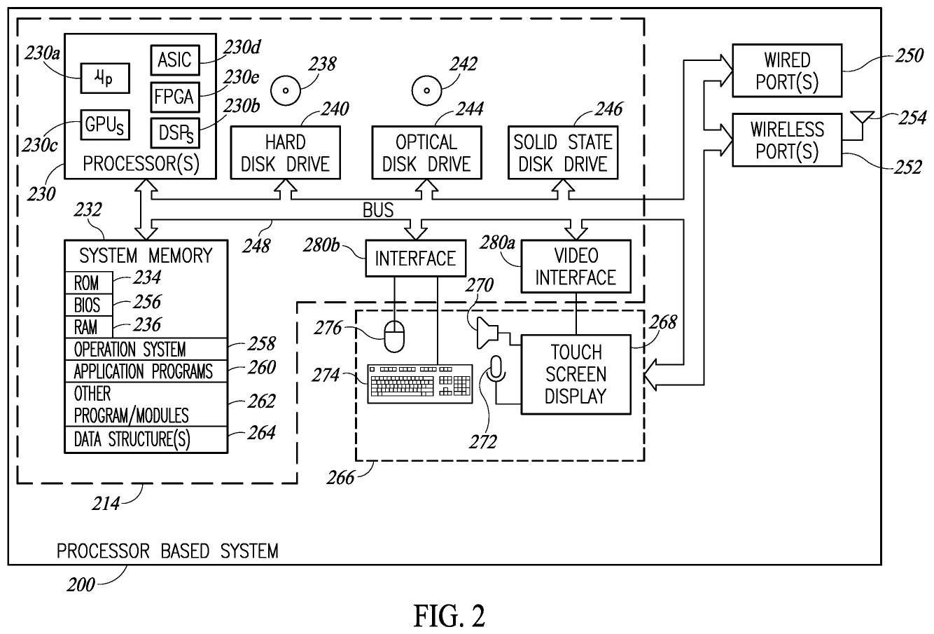

FIG. 2 shows a processor-based system 200 according to at least one illustrated implementation. Instances of the processor-based system can implement any one or more of a rights bound token server system 100, a blockchain server system 104a-104d, and/or the client processor-based systems 108 (FIG. 1) depending on the processor-executable instructions executed by the processor(s) thereof.

The processor-based system 200 may include one or more processors 230, for example, one or more of: one or more microcontrollers, one or more microprocessors, 230a one or more central processing units, one or more digital signal processors (DSPs) 230b, one or more graphics processing units (GPUs) 230c, one or more application specific integrated circuits (ASICs) 230d, one or more field programmable gate arrays (FPGAs) 230e, and/or one or more programmable logic controllers (PLCs) (not shown). The processor-based system 200 may include one or more nontransitory storage media, for example, one or more nonvolatile storage media and/or one or more volatile storage media, for example a system memory 232 that includes one or more of: one or more read only memories (ROMs) 234, one or more random access memories (RAMs) 236, one or more magnetic disk 238 and associated drives 240, one or more optical disk drives 242 and associated drives 244, one or more solid state drives 246 (e.g., FLASH memory), one or more cache memories, and/or one or more registers (not shown) of one or more processors 230. The processor-based system 200 may include one or more communications channels 248 (e.g., buses) that communicatively couple the processor(s) with the storage media. The processor-based system 200 may include one or more communications ports, for example one or more wired communications ports 250, wireless communications ports 252 (e.g., Wi-Fi and/or Bluetooth radios and associated antennas 254; infrared transceivers) that provide for communications between the processor-based system 200 and external devices.

The processor(s) 230 of the processor-based system 200 are operable to execute logic, for example to execute one or more algorithms stored as process-executable instructions by the one or more nontransitory storage media. Suitable algorithms are set out herein, for example with reference to the various flow diagrams. Process-executable instructions may, for example, include a basic input/output operating system (BIOS) 256, for example stored in ROM 234.

Process-executable instructions may, for example, include an operating system (OS) 258, for example stored in RAM 236 during execution. Process-executable instructions may, for example, include one or more application programs 260, which provide the logic to generate and/or manage rights bound tokens using blockchains and establish evidence of a chain-of-custody for the same as described herein, the applications program(s) stored, for example, in RAM 236 during operation. Process-executable instructions may include one or more other programs or modules 262, for example to provide for communications with external devices and which may be stored, for example, in RAM 236 during execution. One or more data structures 264 may store information, for example information that identifies specific users, blockchain wallets, rights packages, tokens, and external and/or internal bindings. The data structures 264 may take a variety of forms including databases, data sets, records and fields, tables, linked lists, trees, binary trees, etc. The data structures 264 may be stored, for example, in RAM 236 during execution.

The processor(s) 230 of the processor-based system 200 are communicatively coupled operable (e.g., wired, optical, wireless or radio) to allow an end user to access a rights bound token server to generate a rights bound token using any of a variety of blockchain server systems 104 (FIG. 1) operated by respective blockchain service providers 106 (FIG. 1), and employing blockchains formed via the processor-based systems 108 (FIG. 1). The processor(s) 230 of the processor-based system 200 are also operable to receive user input from, and provide user out to, one or more user interface devices of a user interface system 266, to allow a human user to interact with the system 200.

The user interface system 266 may, for example, include one or more of: one or more display screens, one or more touch-sensitive display screens 268, one or more speakers 270, one or more microphones 272, one or more keyboards 274, and/or one or more pointer devices 276 (e.g., computer mouse, trackpad, trackball). The components of the user interface system 266 are communicatively coupled (e.g., wired, optical, wireless or radio) with the processor(s) 230 via one or more peripheral interfaces 280aa, 280b to provide user input to the processor(s) 230 and to receive output from the processor(s) 230 to be presented to a user. In particular, the processor(s) 230 may execute processor-executable instructions that cause the processor(s) to cause devices to present a user interface (e.g., a graphical user interface), for instance via a touch screen display 268. Various user interface elements are illustrated and described herein.

The user interface (UI) system 266 can include one or more user interface (UI) components, for example one or more switches, triggers, display screens (e.g., LCD display), lights (e.g., LEDs), speakers, microphones, haptic engines, graphical user interfaces (GUIs) with via a touch-sensitive display screen which displays user-selectable icons operable to allow input to the processor-based system 200 and/or output from the processor-based system 200. The UI components allow a user to control operation and/or optionally to receive information. For example, a user may press a button, key or trigger, or can use eye movements to provide input to the processor-based system 200.

Various implementations described herein may include, or may operate by, logic or a number of components, or mechanisms. Circuitry is a collection of circuits implemented in tangible entities that include hardware (e.g., simple circuits, gates, logic, etc.). Circuitries include circuit elements that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation.

The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating.

In an example, one or any combination of the hardware processor(s) 230, system memory 232, magnetic disk 238, optical disk 242 and/or solid state drive 246 constitute machine-, computer- or processor-readable media. The terms “machine-readable media”, “computer-readable media” and “processor-readable media” may include a single medium or multiple media (e.g., a centralized or distributed database, and/or associated caches and servers) operable to store one or more computer- or processor-executable instructions. The terms “machine-readable media”, “computer-readable media” and “processor-readable media” include any medium that is capable of storing, encoding, or carrying instructions for execution by the processor(s) 230 and that cause the processor(s) 230 to perform any one or more of the techniques of the present disclosure, or that is capable of storing, encoding or carrying data structures used by or associated with such instructions. Non-limiting examples of terms “machine-readable media”, “computer-readable media” and “processor-readable media” include solid-state memories, and optical and magnetic media. The terms “machine-readable media”, “computer-readable media” and “processor-readable media” do not include non-transitory propagating signals. Examples of nontransitory machine-readable media, nontransitory computer-readable media and nontransitory processor-readable media include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; and CD-ROM and DVD-ROM disks.

Communications can utilize any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, interface devices may include one or more physical jacks (e.g., Ethernet, coaxial, or phone jacks) or one or more antennas to connect to the communications network 826. In an example, interface devices may include a plurality of antennas to wirelessly communicate using at least one of single-input multiple-output (SIMO), multiple-input multiple-output (MIMO), or multiple-input single-output (MISO) techniques. The term “transmission medium” shall be taken to include any tangible medium that is capable of storing, encoding or carrying instructions for execution by the control subsystem 200, and includes digital or analog communications signals or other intangible medium to facilitate communication of such software.

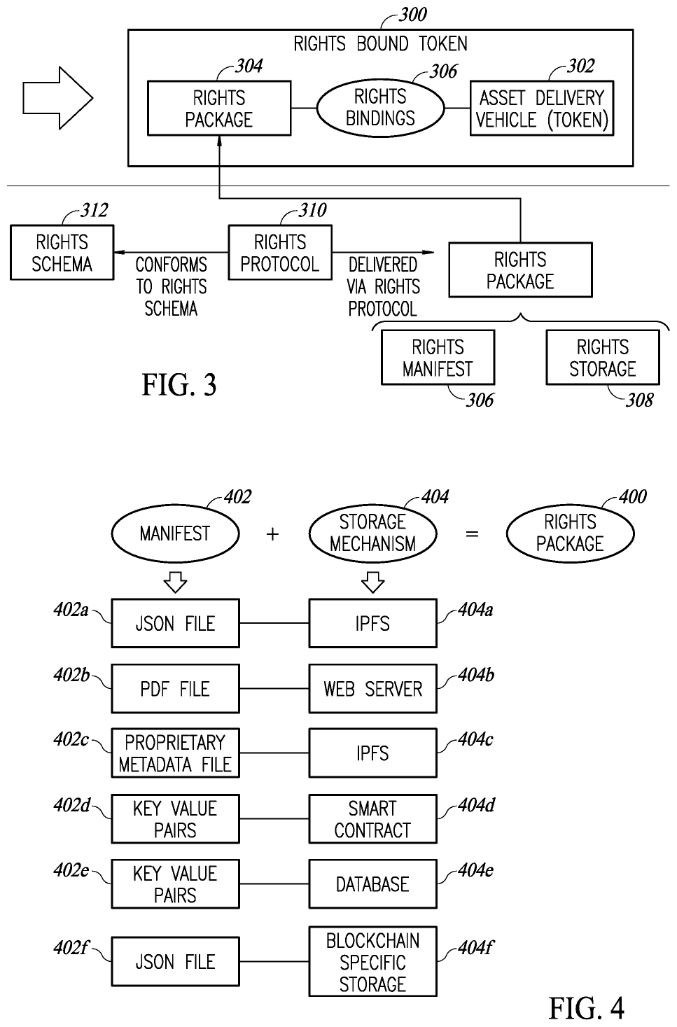

FIG. 3 shows a rights bound token (RBT) 300 including a number of constituent components thereof, including an asset delivery token 302, one or more rights packages 304, and one or more rights bindings 306 (at least one rights binding) that binds the rights packages 304 to the asset delivery token 302, according to at least one illustrated implementation.

RBTs are digitally native, decentralized assets that exist as part of a blockchain ecosystem. An RBT is comprised of a blockchain token, which can be fungible or non-fungible, and a structured rights package, inextricably bound to each other by a secure binding.

An RBT can be created on a blockchain as a tokenized asset. The owner of an RBT is the owner of the blockchain wallet address that holds the token. When created, and as a result of a structured rights package inextricably bound to the token, an RBT is an asset that inherently and/or intrinsically establishes and represents a set of rights that are recognized and can be valued based on real world value.

Currently, a nonfungible blockchain token (NFT) when created via a smart contract only conveys to the owner of the NFT the ownership of a token identifier, which has no intrinsic value. The NFT does not convey explicit ownership or rights to anything else (e.g., rights to property, copyrights, trademark rights, usage, or any other rights). Creating an NFT can be compared creating a class of preferred stock that has no attributes or rights associated with the class. The stock may exist, but provides the owner of the shares nothing of value. In this sense, NFTs are merely the technical infrastructure for a token identifier. In contrast, an RBT is an asset class with a set of rights that are recognized and can be valued based on real world value.

RBTs have various characteristics. An RBT can, for example, be transferable or non-transferable. Also for example, an RBT can have multiple rights associated to it in one rights package. Also for example, an RBT can have multiple rights packages associated to it. The rights associated with an RTB can change or evolve over time. An RBT has point in time integrity, meaning that it is clear what rights exist for a respective RBT at any given point in time. Thus, there is no ambiguity as to the rights at any given point in time for any given owner.

The asset delivery token 302 is a token on a blockchain, providing immutability. The rights packages 304 comprises a combination of a rights manifest 306 and a specification of a rights storage mechanism 308. The rights package 304 specifies a rights protocol 310 which in turn conforms to a rights schema 312. As described herein, the rights manifest 306 can take a large variety of forms. As described herein, the rights storage mechanism 308 can take a large variety of forms. As best described with reference to FIG. 4 and the accompanying discussion, below, the approach described herein advantageously allows various combinations of rights manifests 306 and rights storage mechanisms 308 to be employed, the particular combination selected to satisfy particular use cases, allowing a generic system to autonomously tailor the generation of rights bound tokens based on various specified criteria.

The rights protocols 310 are a comprehensive set of data that articulates all elements that constitute a sound rights construct for a particular RBT. The rights protocols 310 always conform to and/or are validated against a schema (i.e., standards driven). Rights protocols 310 are represented by a rights manifest 306 that is stored in a particular way to facilitate the use of blockchain technologies. The rights protocols 310 can be thought of as a “common language” that allows heterogeneous systems that understand the rights protocol 310 to interact with each other. The rights protocol 310 does not dictate the format of the data elements, but rather dictate that certain data elements exist. In fact, it should assume that the format of the data can take many forms and be transformed between formats whenever useful to do so. The protocol conforms to a standards driven rights schema. There is typically not one rights schema 312 but rather a set of rights schemas 312 that are conformant driven by what type of rights are being represented by the rights protocol 310. If a rights protocol 310 is valid according to its rights schema 312, it should be able to interact with various applications, smart contracts, etc., and hence function without issues. In at least some instance, the rights protocol 310 may exist in more than one rights manifest 306, resulting in multiple rights packages 304 associated with a single token 302. The rights protocols 310 can require that at least one intellectual property right be specified in order to be considered a valid protocol.

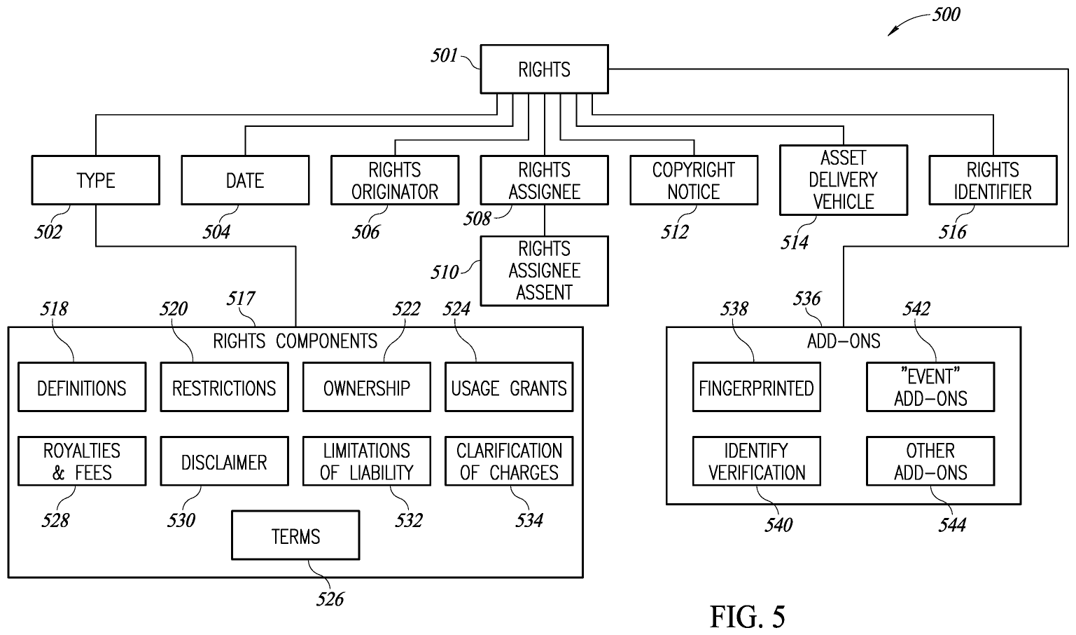

The rights schema: 312 defines the particular required data elements and the optional data elements for a particular rights protocol 310. The rights schemas 312 are used to ensure standardization and are used to validate a rights protocol 310. The particular rights schema 312 that is chosen is selected based on the rights needed for the particular token (knowing that there are many components of rights). A rights schema 312 can have required and optional attributes. Any instance of a rights protocol 310 can always be validated against its corresponding rights schema 310. The rights schemas 310 are preferably standards driven. There is a core meta-schema (see FIG. 5 and accompanying discussion) that at a macro level represents all of the possible data elements that a rights schema 310 might have. some of those data elements may be required of every “child” schema. Other of those data elements may only be required if the corresponding rights package is representing rights of a certain type. A particular instantiation of a rights schema 310 cannot be changed, however rights schemas 310 themselves can definitely evolve over time. The rights schemas 310 should be backwards compatible, but in rare cases that may not be possible.

The rights manifest 306 is a physical representation of an instance of a specific rights protocol 312 based on a specific rights schema 310. In particular, the rights manifest 306 is the physical representation of an “instance of” a specific rights protocol 312. A specific instance of the rights protocol 312 can be represented in a variety of ways, advantageously allowing flexibility. For example, an instance of the rights protocol 312 could be physically represented as a JSON file. Also for example, an instance of the rights protocol 312 could be physically represented as a series of key/value pairs, or as an XML file, or as one or more records in a database (e.g., flattened or not flattened). It is preferably if the rights manifest 306 is machine- or processor-readable, although such is not necessarily a requirement.

The rights storage mechanism 308 is the physical storage mechanism of the rights manifest. Such is described in more detail with reference to FIG. 4 and the accompanying discussion, below.

As described above, the rights package 304 is a combination of the rights manifest 306 and the rights storage mechanism 308. The rights package 304 is what can be acted up by external parties and applications. A single asset delivery token 302 can have multiple rights packages, and thus multiple bindings. The rights package 304 can be stored on-chain or in some other immutable form (e.g., IPFS).

The rights bindings 306 are the physical tie between the rights package 304 and the asset delivery token 302. For an RBT 300 to exist—the “rights” are “bound” to the “token”. The binding happens at a physical layer. Bindings are preferably distributed, immutable, permanent, and discoverable. An RBT 300 has at least one on-chain independent binding external to the asset delivery token 302 and the rights protocol 312. The external or primary binding can, for example be a cryptographic binding, for example a cryptographic two way binding. Bindings should be considered a separate entity that allows for the evolution of the token separate and distinct from the evolution of the rights protocol 312. Bindings can be a one way binding or a two way binding. There can, and often will, be multiple bindings between the rights package 304 and the asset delivery token 302. (Example) The asset delivery token 302 and the rights protocol 312 may have bindings that are internal. All bindings should be validated.

An internal binding is a binding that exists within (in some sense is embedded within) one of the components of the RBT, the components being the asset delivery token 302 itself and/or the rights package 304. An external binding is a binding that exists outside the asset delivery token 302 and the rights package 304. An external binding is such that if either the asset delivery token 302 or the rights package 304 disappeared, the external binding actually still exists, albeit with the fact that the external binding now binds components that no longer exist. (That said, because blockchain transactions are permanent and immutable, it is not really possible for such to “no longer exist”. Put another way, an external binding is a construct of its own (a first class citizen) that references, in a permanent, immutable way, the two things that are bound. An internal binding is not decoupled from either of the components that it is binding. An external binding is completely decoupled from the components that it is binding. Having internal bindings can be of much value as it allows for “direct” discovery without having to “hop”. However, if only internal bindings exist, it reduces the value of the RBT as a whole because is limits flexibility and scalability of RBTs.—For example, such would limit the ability to have the evolution of either the asset delivery token 302 or the rights package(s) 304 on its own. In some cases, depending on the immutability of the component that holds the internal binding (e.g., the NFT metadata), internal bindings can be incomplete and thus dangerous as such could give an incorrect set of rights packages that exist for that asset delivery token 302. In some sense, internal bindings can be viewed as “secondary” bindings which have value but without an external (primary) binding, the value of RBT as a whole is diminished. This is why an RBT has at least one external binding to be valid. An internal binding can be viewed as “useful but not sufficient”. Whereas an external binding can be viewed as “sufficient but not always as efficient as desired.”

For example, if an external system (not a rights bound token creation and management engine (C&ME)) is acting upon or displaying something about an RBT, an internal binding can make it more efficient/easier for that external system to display or act upon the associated token or rights because the external system doesn't have to “go somewhere else” to find the binding(s). Having an external binding is advantageously facilitates scalability. It could become impossible to discover the complete set of bindings if one has to be able to search every individual component (rights package 304 and asset delivery token 302) in order to construct a comprehensive set of bindings. This does not mean that there can only be one source of external bindings, it simply means that bindings should be findable on their own to be able to scale infinitely. Fundamentally, having an external binding agent that is on-chain provides many of the advantages described herein, and can advantageously be implemented as a blockchain specific smart contract. (This can be thought of as a binding agent).

It is noted that the technical mechanism to achieve distributed, immutable, permanent, decentralized, verifiable, evolvable is not just limited to only the use of blockchain but can also additionally employ other Web3 technologies (e.g. IPFS).

FIG. 4 shows how a rights package 400 is formed from a combination of a rights manifest 402 and a rights storage mechanism 404, according to at least one illustrated implementation.

In particular, FIG. 4 illustrates some example combinations of manifests 402a, 402b 402c, 402d, 402e, 402f and storage mechanisms 404a, 404b 404c, 404d, 404e, 404f (six combinations illustrated) that can be employed to form a rights package 400 of a rights bound token. Manifests 402 can, for example, take the form of JSON file 402a, 402f, PDF file 402b, proprietary metadata file 402c, or key value pairs 402d, 402e. Rights storage mechanisms 404 can, for example, take the form of IPFS 404a, 404c, Web server 404b, smart contracts 404d, a database 404e or a blockchain specific storage 404f. It is recognized that use of a Web server 404b as a storage mechanism typically does not provide immutability, thus a Web server 404b typically will not be a preferred storage mechanism. Such is illustrated as an example of the large variety of combinations of rights manifests and rights storage mechanisms that could be employed.

Due to the nature of blockchain and Web3, the selection of a combination of rights manifest 402 and rights storage mechanism 404 is more than simple implementation details. An RBT creation and management engine (C&ME) advantageously recognizes the rights manifest 402 and rights storage mechanism 404 as different aspects, and has the ability to create RBTs with different manifests and storage mechanisms, allowing wide adoption of RBTs and use across heterogeneous blockchain service. One example of this is that smart contracts typically require payment (aka gas fees) to be able to store data in the smart contract. Thus, one may not want to, or even be able to, use that smart contract as the rights storage mechanism. But one may still want the rights manifest to be stored in an immutable, distributed and permanent way. Thus, the RBT C&ME can have the rights manifest stored in IPFS which offers the characteristics of being immutable, distributed and permanent, but is not technically on-chain. Different blockchains have different philosophies about data, storage and fees. Consequently, the RBT C&ME can advantageously abstract out the rights manifest and rights storage mechanism to be able to be blockchain agnostic as well as efficient. For example, the Flow blockchain very specifically describes what type of data that should or should not be stored “on chain” versus stored “off chain but permanent”. Ethereum limits the amount of data that can be stored on a particular smart contact. Notably, should be appreciated that data and storage of data in Web3/blockchain will continue to evolve, and the RBT C&ME should accommodate rights manifests and rights storage mechanisms that evolve over time, which is best realized by abstracting those out as specific components of the RBT and as specific components of the RBT C&ME.

FIG. 5 shows an exemplary rights protocol meta-schema 500 for use with a rights bound token, according to at least one illustrated implementation.

The exemplary rights protocol meta-schema 500 specifies various rights package components for each right 501 covered by a rights package of an RBT. The rights package components, for each right 501 can, for example: include: rights type 502, rights date 504, rights originator 506, rights assignee 508, rights assignee assent 510, rights notice 512, asset delivery vehicle 514 (i.e., token, aka tokenized asset), and rights identifiers 516. The type of information represented by each of these rights package components is readily understood from the names of the respective rights package components, although at least a few will be described below.

The rights type 502 specifies a fundamental type of right that is, or will be, the subject of the RBT. Types of rights include, for example, an event, ownership of a creative work, ownership of tangible property, etc. Each rights type 502 has a subset of associated rights type components 517. The type of right (rights type 502) determines the specific rights type components 517 that apply.

The rights type components 517 can include, for example, one or more of: rights definitions 518, a set of restrictions 520, ownership 522, usage grants 524, terms 526, royalties and fees specification 528, disclaimers 530, limitations of liability 532, and/or a clarification of changes 534. It is noted that various ones of the rights type components can potentially be represented by respective executable smart contracts. The type of information represented by each of these rights type components is readily understood from the names of the respective rights components, although at least a few will be described below.

The rights date 504 specifies a date associated with the specific rights, for example a date of creation of the right (e.g., copyright date) and/or a date of expiration of the right. The rights originator 506 specifies an identity of an entity (e.g., person, business) that originated the right (e.g., author, trademark holder). The rights assignee 508 specifies an identity of an entity (e.g., person, business) that is an assignee of the rights. The optional rights assignee assent 510 provides evidence of an assignee assenting to the rights that were transferred. The rights notice 512 specifies a type of notice associated with the specific rights, e.g., copyright notice, trademark notice, patent notice. The asset delivery vehicle 514 specifies the asset delivery vehicle being employed for the right, for example a specific asset delivery or token (e.g., unique asset delivery token identifier, unique smart contact identifier). The rights identifiers 516 identifies the rights package (e.g., rights storage mechanism identifier or pointer to rights manifest, rights manifest identifier or pointer to rights manifest).

Returning to the rights type components 517, the rights definitions 518 defines the rights, for example a right in real property, a right in tangible property, a right in intangible property for instance in intellectual property. The set of restrictions 520 can specify certain restrictions on the rights, for example restricting copyright to displays of the work but not reproduction of a copyrighted work of authorship, or restricting copyright to the right to make copies but not the right to make derivative works, or restricting the use of trademarks to certain types of goods or services. The ownership 522 identifies an entity (e.g., human, business, collective) that owns the right. The usage grants 524 specifies certain permitted usage, for example an easement onto or across real property, use of copyright materials for education or noncommercial purposes. The terms 526 specify specific terms around the rights and use or enjoyment of such rights. The royalties and fees specification 528 specifies the various terms for payment of royalties and/or other fees attendant on use of the right. The disclaimers 530 include specific disclaimers with respect to the right, for example disclaimers of warranties of fitness or disclaimer of warranty with respect to infringement of third party rights. The limitations of liability 532 specify limitations of liability associated with the right, for example limiting liability for usage of certain real property or tangible property. The clarification of changes 534 can specify any details regarding changes with respect to the right.

As indicated in FIG. 5, a rights package can optionally include various add on components 536. For example, the rights package can optionally include one or more digital fingerprints 538, the digital fingerprints providing verification or authentication of the rights. The rights package can optionally include an identity verification 540 providing verification or authentication of an entity associated with the rights, for example an originator, owner, and/or transferred. The rights package can optionally include an event add on 542 and/or other add on 544. Such can, for example, allow additional rights or a promotion to be associated with the right. For example, a promoter can provide a digital copy of a song to the holder of a ticket for a concert or other event via the event add on 542. Such can, for example, allow additional rights or a promotion to be associated with the right. For example, a promoter can provide a digital copy of a song to the rights holder for a purchased book about a performer via the other add on 544.

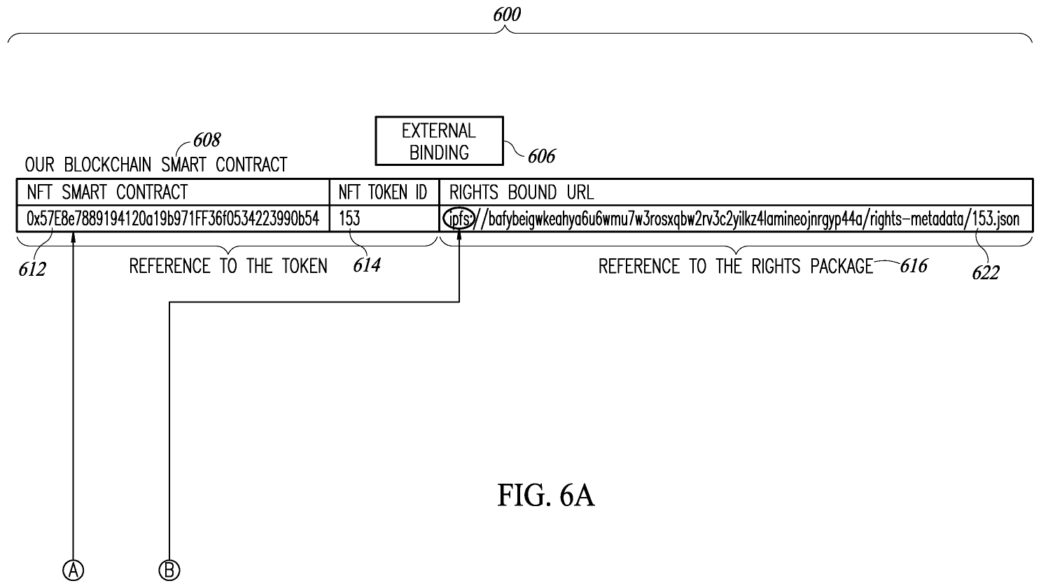

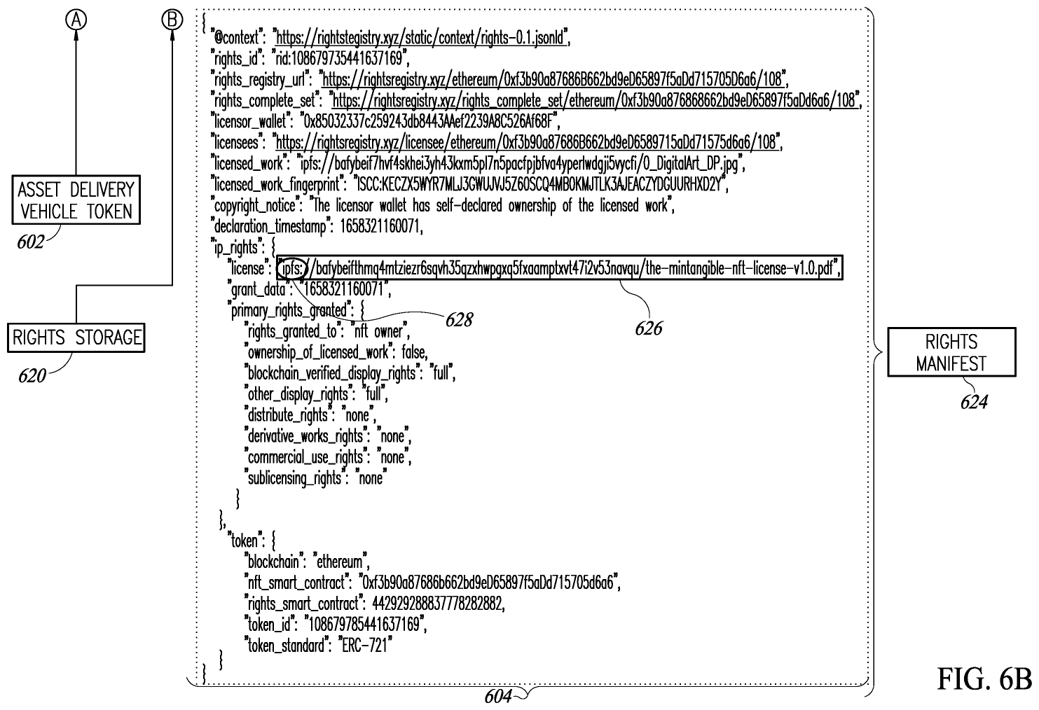

FIGS. 6A and 6B show an example RBT 600 with an exemplary asset delivery token 602, a rights package 604, and an external rights binding 606 that binds the rights packages 604 to the asset delivery token 602. The RBT 600, asset delivery token 602, rights package 604, and external rights binding 606 can implement the previously illustrated and described RBT 300, asset delivery token 302, rights package 304, and rights bindings 306 (FIG. 1).

In the example of FIGS. 6A and 6B, an RBT 600 is illustrated implemented as a blockchain smart contract 608. Thus, the blockchain smart contract 608 can specify the asset delivery token 602 via a reference 610, for instance where the reference 610 is to a unique blockchain smart contract identifier 612 (e.g., 0x57E8e7889194120a19b971FF36f0534223990b54) and a token identifier 614 (e.g., 153). The RBT 600 can specify the rights package 612 via reference or pointer 616, for instance which includes a rights storage mechanism identification 618 that identifies a rights storage mechanism 620 and either includes a rights manifest storage location identifier or pointer 622 that identifies a location or points to a rights manifests 624 or which stores the rights manifests 624 itself.

FIGS. 6A and 6B also illustrates an example of a rights manifest 618. Notably, the rights manifest 618 includes a reference to a license 626. The rights manifest 618 stores an indication 628 of where a license is stored. in this example, the license is stored on IPFS, which while off chain is an immutable form.

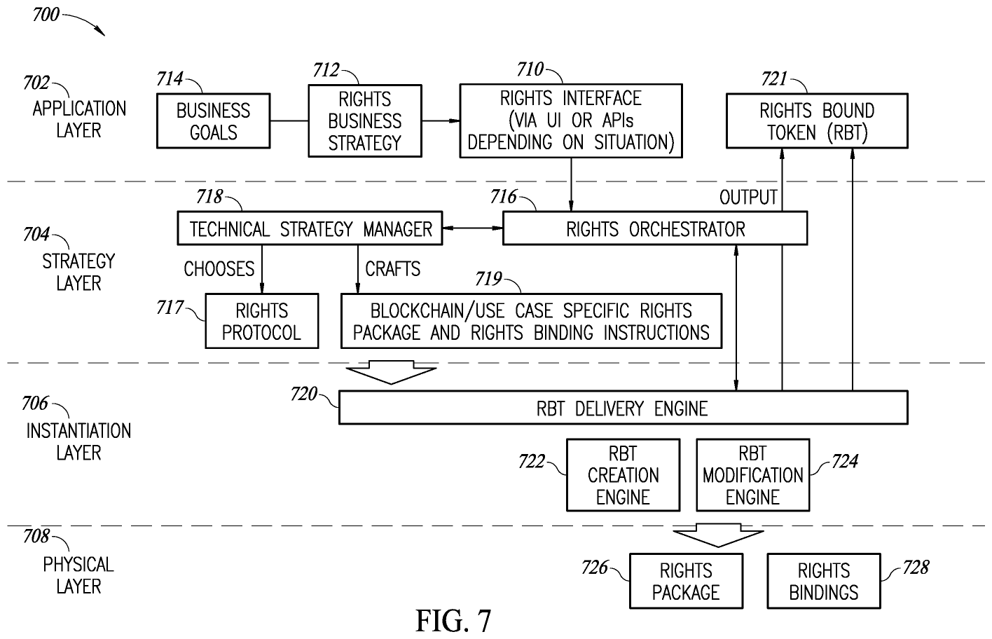

FIG. 7 shows an exemplary rights bound token (RBT) creation and management engine (C&ME) 700 of a rights bound token server operable to generate a rights bound token, according to at least one illustrated implementation.

The RBT CM&E 700 comprises a comprehensive set of abstractions, components, interactions, layers and technologies useful in having a thriving, robust, valid and eternal RBT asset class. Such is possible due to the recent emergence/existence of blockchain and Web3 technologies. The RBT C&ME 700 is advantageously blockchain agnostic, and not is blockchain or NFT project specific so as enhance the overall usefulness RBTs as an asset class.

The RBT C&ME 700 preferably contains all of the components that allow for: instantiation of a RBT; evolution of the rights associated to the RBT; ongoing assent of rights as the RBT is transferred (bought/sold); ensuring point in time integrity of exactly what rights are associated to the RBT; and ensuring point in time integrity of exactly who has the rights. The RBT C&ME 700 can also include components that allow for selection or implementation of a “best” strategy for instantiation of an RBT taking into account one, more, or all of: technical limitations and opportunities, pre- and post-facto processing; cost of creation and maintenance; and optionally business strategy. The RBT C&ME 700 can also include components that allow for ongoing monitoring, discoverability and notifications around RBTs and their associated rights. The RBT C&ME 700 can also include components that account for blockchain as a foundational technology, be blockchain agnostic, and account for Web3 concepts of distributed, immutable, permanent, decentralized, verifiable, permissionless, trustless.

The RBT CM&E 700 can be categorized into an application layer 702, a strategy layer 704, an instantiation layer 706 and a physical layer 708, although other arrangements are possible. Components of the various layers interact with one another, for example as illustrated in FIG. 7.

The application layer 704 includes a rights interface 710. The rights interface 710 can be accessed via a user interface and/or via calls via an application programming interface (APIs). The rights interface 710 is feed by a rights strategy manager 712, which itself is feed by goals 714. The rights strategy manager 712 includes logic that selects appropriate components for a RBT based on criteria provided via the rights goals 714. For example, the rights strategy manager 712 selects an appropriate combination of rights storage mechanism and rights manifest to generate a rights package consummate with the goals based on defined logic that takes into account one or more of: cost of creation and maintenance; optionally business strategy, optionally technical limitations and opportunities, and/or pre-facto processing and post-facto processing.

The strategy layer 704 principally includes a rights orchestrator 716. The strategy layer 704 can also include a technical strategy manager 718 which interacts with the rights orchestrator 716. The technical strategy manager 718 is has two primary responsibilities. Based on the inputs from the rights orchestrator 716, the technical strategy manager 718 chooses the most appropriate rights protocol 717 to meet the goals. The technical strategy manager 718 also knows the technical opportunities and limitations specific to a blockchain, a marketplace or any third party interactor, to ensure that the creation or evolution of an RBT is possible and is executed correctly. The technical strategy manager 718 could even craft a cross-blockchain strategy.

As noted above, the technical strategy manager 718 selects rights protocols 717. For example, the technical strategy manager 718 selects an appropriate rights protocol 717 to generate blockchain and/or use case specific rights packages and rights binding instructions 719 consummate with the selected rights protocols 717. Such can be based on defined logic that takes into account one or more of: technical limitations and opportunities and/or pre- and post-facto processing. The technical strategy manager 718 can craft or generate blockchain/use case specific rights packages and rights binding instructions.

The instantiation layer 706 can include a rights bound token engine 720 that is operable to generate the rights bound tokens 721. The RBT delivery engine 720 accepts instructions from the technical strategy manager 718 and performs the physical implementation of those instructions. For example, the instantiation layer 706 can include a rights bound token creation engine 722 that creates or generates the rights bound tokens 721. The rights bound token creation engine 722 can create or generate a rights package and bind the rights package to an asset delivery vehicle or token, where for example the asset delivery vehicle or token was minted by a separate system (e.g., an external blockchain service). The rights bound token creation engine 722 can listen for the minting of tokens via various blockchain services. Also for example, the instantiation layer 706 can also include a rights bound token modification engine 724 that modifies existing rights bound tokens 721. Modification of rights bound tokens 721 is described elsewhere herein, including with respect to the algorithms illustrated by the flow diagrams.

The physical layer 708 is where the rights packages 726 and rights bindings 728 reside.

The ecosystem around NFTs is still in its infancy and thus there are many innovations, and even possibly necessities, around the creation and ongoing management of NFTs. One primary example of this is that many NFT creators do not want to actually mint the NFT until there is an active buyer wanting to purchase the NFT. This presents a technical chicken and egg situation. You want rights to be instantiated at the time of creation of the NFT (so that it is actually an RBT) but in order to do that you have to have created the rights ahead of the NFT creation. Because you want immutability and permanence, the order of operations both matters and must be handled appropriately in order to maintain immutability but be created ahead of the instantiation of the token. There is also post-facto processing that also must be done in a way that maintains the immutability and permanence but allows for evolution. (see the slide about Rights Protocol Evolution). In order to handle pre- & post facto processing the C&ME must properly create and store rights protocol data in a very careful mix of web2 and web3 technologies in order to be able to have created the rights ahead of (or after) the minting of an NFT but actually do the instantiation of the rights on the blockchain either synchronously at the time of minting or post minting but in a guaranteed way. This is precisely why the Rights Orchestrator 716 a) exists off-chain and b) utilizes a mix of Web2 and Web3 technologies to, for example, create immutable rights packages and yet not have those rights packages instantiated (declared) on the blockchain until certain events have occurred. This provides a significant advantage over other approaches.

Post-facto processing enhances the usefulness of RBTs since such is affected by the ability for the rights protocol to evolve over time. There are two aspects to rights protocol evolution. The evolution of the underlying rights, as well as, ongoing acknowledgement of the rights. Both are preferably accounted for in order to have a long lived valid RBT.

First, addressing the evolution of the underlying rights, the initial protocol for a particular RBT might, for example, include a right to display a creative work, but does not include a right to employ the creative work to make shirts with the creative work appear on the shirts. However the IP owner may decide in future to offer the right to make shirts using the creative work. The rights protocol can accommodate such later grant of rights. Another example would be if the initial protocol for a particular RBT gives the holder of the RCT entrance to a particular event. Subsequently, the creator of the RBT decides to offer early access to a new song that will be released. Again, the rights protocol can accommodate such later grant of rights.

Second, addressing the ongoing acknowledgement of said rights, it is expected that an instance of an RBT will be transferred (e.g., bought/sold) over time. Each new owner can be queried, or even required, to affirmatively assent to the rights that are part of that RBT at the time of transfer. The protocol can include every rights assent transaction within the protocol.

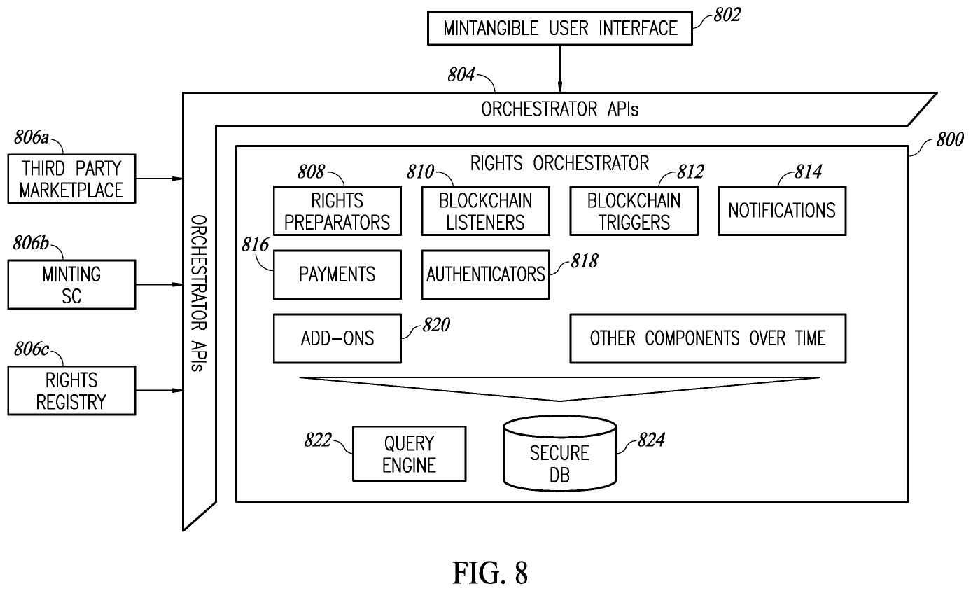

FIG. 8 shows a rights orchestrator 800 of a creation and management engine (C&ME) (FIG. 7) accessible via a user interface 802 and/or via APIs 804 and operable to generate a rights bound token, according to at least one illustrated implementation.

The user interface 802 and APIs 804 allow the rights orchestrator 800 to interact with various external systems and servers, for example via third party marketplaces 806a, minting a smart contract 806b, and a rights registry 806c.

The role of a rights orchestrator 800 is to coordinate all relevant inputs and act as the primary driver of the ability to create an initial RBT as well as modify or terminate the RBT accordingly over time. The rights orchestrator 800 intentionally utilizes primarily Web2 technologies. It is not necessarily the case that the rights orchestrator 800 will participate in all modifications of an RBT over time. In fact, the opposite may be true. Some modifications to the RBT will intentionally happen outside of the rights orchestrator 800. For example, some assents upon transfer of ownership will execute directly smart contract to smart contract with no coordination happening via the rights orchestrator 800. One way to view of the rights orchestrator 800 is as the “use case” logic, that is logic that knows how to identify the elements of the use case that would impact the eventual technical strategy chosen. The rights orchestrator 800 knows how to organize the inputs to be able to send to the technical strategy manager 718 (FIG. 7) in a way that the technical strategy manager 718 can then perform its own function”. The rights orchestrator 800 typically has access to a database of its own. The rights orchestrator 800 utilizes access to this database to be able to allow for pre-certified RBTs as well as other pre- and post-facto acts and creations for an RBT.

To implement such, the rights orchestrator 800 includes rights preparators 808 which can prepare the components used in generating RBTs, for example preparing a rights package. The rights orchestrator 800 also includes blockchain listeners 810 which can listen for activity one various blockchain services, for example listening for the minting of a token that can be employed as an asset delivery vehicle in generating an RBT. The rights orchestrator 800 can also include blockchain triggers 812 operable to trigger a blockchain service to provide a token. The rights orchestrator 800 can also include a notifications module 814 operable to provide notifications, for example to the owners of rights or holders of RBTs. The rights orchestrator 800 can also include payments module 816 operable to handle payment activity, for example payments for generation, management and/or modifications of RBTs and for smart contracts (e.g., gas). The rights orchestrator 800 can also include authentications module 818 operable to perform authentications of RBTs, users, assignees. The rights orchestrator 800 can also include add on modules 820, for example operable to execute any of the add on activities previously described in reference to FIG. 5. The rights orchestrator 800 can also include a query engine 822 and a secure database 824. The query engine is operable to query the secure database 824, for example as previously described with reference to FIG. 7.

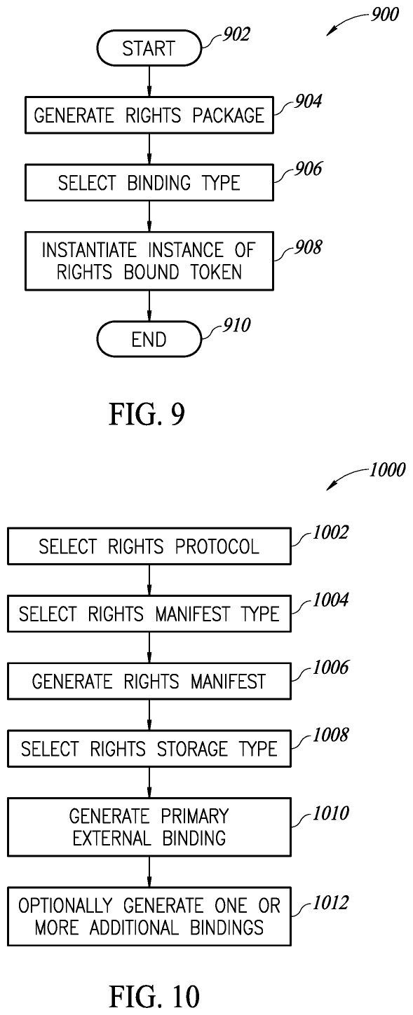

FIG. 9 shows a method 900 of operation of a rights bound token creation and management system, which can for example be implemented as a rights bound token sever, according to at least one illustrated implementation. The method 900 can be executed by the systems of any of the implementations illustrated or described herein, for example by the rights bound token sever 100 (FIG. 1), processor-based system 200 (FIG. 2), or rights bound token creation and management engine 700 (FIG. 7).

The method 900 starts at 902, for example in response to power ON or starting up of the system, or in response to a call or invocation by a calling routine.

Optionally at 904, the system generates at least one rights package based on at least one set of criteria. The at least one rights package specifies at least one right that is based on the at least one set of criteria. Generating at least one rights package based on at least one set of criteria can, for example, include generating at least one rights package that specifies a set of rights in an asset beyond the rights bound token itself. The rights can, for example, include one or more of: a right in tangible property, right in real property, a right in intellectual property, a right to usage of an asset, or an easement right. Generating at least one rights package based on at least one set of criteria can, for example, include generating at least one immutable rights package, that is a rights package that is immutable and not subject to change at least without rendering invalidating the rights package or otherwise leaving a detectable indication that the rights package has been tampered with. Generating the at least one rights package can, for example, occur prior to a minting of a tokenized asset or can occur subsequent to a minting of the tokenized asset that will be used as the asset delivery vehicle (i.e., token, aka tokenized asset). Generating the at least one rights package can, for example, occur currently with or in conjunction with a minting of the tokenized asset that will be used as the asset delivery vehicle (i.e., token, aka tokenized asset).

Optionally, generating the at least one rights package can, for example occur prior to an instantiating the instance of the rights bound token comprising the tokenized asset on the blockchain inextricably bound to the at least one rights package. Optionally, generating the at least one rights package can, for example, occur prior to a minting the tokenized asset (e.g., asset delivery vehicle).

At 906, the system selects a binding type, for example based on at least one set of criteria. Selecting a binding type, for example, includes selecting at least one external binding type (e.g., for a primary binding), which provides for enhanced security, allowing validation. Selecting a binding type can, for example, include selecting two or more external binding types, which can be different from one another or the same as one another. Selecting a binding type optionally can further include selecting one or more internal binding types in addition to the selected at least one external binding type.

At 908, the system instantiates an instance of an RBT comprising a tokenized asset on a blockchain inextricably bound to the at least one rights package. Instantiating an instance of a rights bound token includes instantiating the instance of the rights bound token with the rights package comprising the rights manifest and the rights storage. Instantiating an instance of an RBT can, for example, include instantiating the instance of the rights bound token with at least one on-chain external binding of the selected external binding type. The at least one on-chain external binding inextricably binds the tokenized asset with the rights package. Instantiating the instance of the RBT with at least one on-chain external binding can, for example, include instantiating the instance of the rights bound token with at least one on-chain external binding that is a blockchain specific smart contract. Instantiating the instance of an RBT can, for example, include instantiating the instance of an RBT using an asset delivery vehicle or token that is either fungible or non-fungible (e.g., NFT).

Instantiating an instance of an RBT can, for example, include instantiating the instance of the RBT where an owner of the instance of the RBT is an owner of a blockchain wallet address that holds the instance of the RBT. Instantiating an instance of an RBT can, for example, include instantiating the instance of the RBT where a transfer of the instance of the RBT conveys a set of rights to a transferee in an asset beyond the rights to possess the RBT itself. Instantiating an instance of an RBT can, for example, include instantiating the instance of the RBT where the instance of the RBT is transferrable, and ownership of the instance of the RBT is definitively discernable at all points in time.

Instantiating an instance of an RBT can, for example, include instantiating the instance of the RBT that has one rights package that specifies multiple rights associated to the instance of the RBT. Instantiating an instance of an RBT can, for example, include instantiating the instance of the RBT that has two rights packages that respectively specify respective rights associated to the instance of the RBT. Instantiating an instance of an RBT can, for example, include instantiating the instance of the RBT in which the rights package of the instance of the RBT specifies at least one right that changes over time, where the at least right is definitively discernable at all points in time. Instantiating an instance of an RBT can, for example, include instantiating the instance of the RBT in which the rights package of the instance of the RBT specifies at least one right that is associated with a smart contract.

Instantiating an instance of an RBT can, for example, include instantiating the instance of the RBT with a tokenized asset on a blockchain inextricably bound to the at least one rights package. Such can, for example, include instantiating the instance of the RBT comprising the tokenized asset on the blockchain inextricably bound to the at least one rights package via a primary external binding, for example when the tokenized asset (e.g., asset delivery vehicle token) is minted for example via an external blockchain service. Instantiating the instance of the RBT can, for example, include instantiating the instance of the RBT comprising the tokenized asset on the blockchain inextricably bound to the at least one rights package via a cryptographic two way binding as the primary external binding.

The method 900 can terminate at 922, for example until or invoked again. Alternatively, the method 900 can run continuously or periodically, for example as a continuous thread of a multi-threaded process. For example method 900 can repeat to generate other instances of rights bound tokens based on respective sets of criteria.

FIG. 10 shows a method 1000 of operation of a rights bound token creation and management system, which can for example be implemented as a rights bound token sever, according to at least one illustrated implementation. The method 1000 can be executed by the systems of any of the implementations illustrated or described herein, for example by the rights bound token sever 100 (FIG. 1), processor-based system 200 (FIG. 2), or rights bound token creation and management engine 700 (FIG. 7).

At 1002, the system selects a rights protocol. The system can employ the technical strategy manager 718 (FIG. 7) and/or the rights strategy manager 712 (FIG. 7) as described above to select an appropriate rights protocol, for example employ various types of logic (e.g., technical, cost, user goals) in selecting the appropriate rights protocol.

At 1004, the system selects a rights manifest type. selecting a rights manifest type can, for example, include selecting a rights manifest type that allows the rights manifest to be stored in an immutable, distributed and permanent form. The rights manifest type can be selected via application of various types of logic, for instance applied via technical strategy manager 718 (FIG. 7) and/or the rights strategy manager 712 (FIG. 7) as described above. Any of a large variety of rights manifest types can be employed, for example those illustrated at 402a-402f of FIG. 4.

At 1006, the system generates a rights manifest based at least in part on the selected rights manifest type. In particular, the system can generate a file or other data structure of a type that corresponds to the selected manifest type, the file including the rights content for the corresponding right, for instance the rights manifest 624 as illustrated in and described with respect to FIGS. 6A and 6B.

At 1008, the system selects a rights storage type. The rights storage type can be selected via application of various types of logic, for instance applied via technical strategy manager 718 (FIG. 7) and/or the rights strategy manager 712 (FIG. 7) as described above. Selecting the rights storage type can include selecting one of a variety of available storage types corresponding to various rights storage mechanisms, for instance the rights storage mechanisms 404a-404f (FIG. 4).

At 1010, the system generates a primary external binding. The primary external binding should be external, and inextricably binds the asset delivery vehicle or token with the rights package. The primary external binding is preferably distributed, immutable, permanent, discoverable. Generating a primary external binding can, for example, include generating a primary external binding via a blockchain employing a distributed ledger (i.e., primary external binding is on-chain). Generating a primary external binding can, for example, include creating a cryptographic hash of a token reference and reference to a rights package and storing the cryptographic has on-chain.

Optionally at 1012, the system generates additional bindings. As noted, the RBT can have one or more additional bindings in addition to a primary external binding. Generating one or more additional bindings can, for example, occur before instantiating the instance of the rights bound token. Generating one or more additional bindings can, for example, include generating one or more additional external bindings, in addition to a primary external binding. Generating one or more additional bindings can, for example, include generating one or more additional internal bindings, in addition to a primary external binding. Generating one or more additional external bindings can, for example, include generating additional external bindings via blockchains employing distributed ledgers. Additionally or alternatively, generating one or more additional external bindings can, for example, include generating additional external bindings that are off-chain, for instance generating a cryptographic function (e.g., a cryptograph hash) that is stored off-chain (e.g., stored in a database). Generating internal bindings can, for example, include generating on-chain or off-chain bindings. For example, generating internal bindings can including generating cryptographic functions (e.g., a cryptograph hash) which could be stored on-chain or off-chain (e.g., stored in a database), for instance using the content of the two objects being bound, and/or generating internal bindings as a blockchain employing a distributed ledger supported by the rights bound token service itself.

Bindings can be a one way binding or a two way binding.

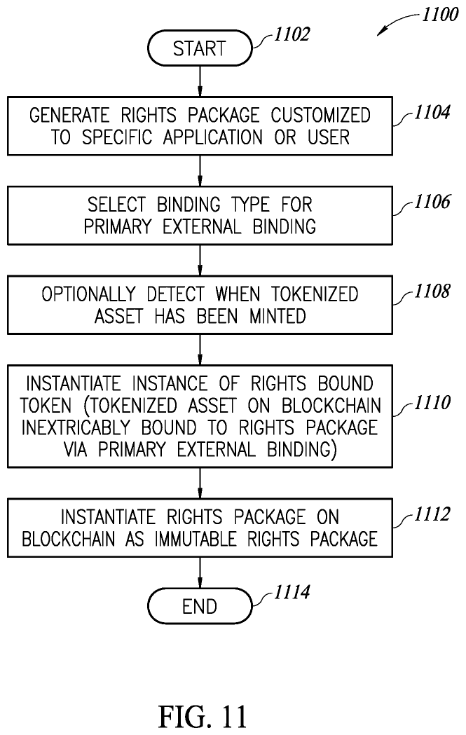

FIG. 11 shows a method 1100 of operation of a rights bound token creation and management system, which can for example be implemented as a rights bound token sever, according to at least one illustrated implementation. The method 1100 can be executed by the systems of any of the implementations illustrated or described herein, for example by the rights bound token sever 100 (FIG. 1), processor-based system 200 (FIG. 2), or rights bound token creation and management engine 700 (FIG. 7).

The method 1100 instantiates a rights bound token before instantiating a rights package on a blockchain. In executing or performing the method 1100, a system can, for example, employ one or more acts of the method 1000 (FIG. 10).

The method 1100 starts at 1102 for example in response to power ON or starting up of the system, or in response to a call or invocation by a calling routine.

At 1104, the system generates at least one rights package customized to a specific application or user. The generation of the rights package has previously been discussed, and such discussion is not repeated in the interest of brevity.

At 1106, the system selects a binding type to be used as a primary external binding. The selection of a binding type has previously been discussed, and such discussion is not repeated in the interest of brevity.

At 1108, subsequent to the generating of the at least one rights package, the system instantiates an instance of a rights bound token comprising a tokenized asset on a blockchain inextricably bound to the at least one rights package via at least the primary external binding. The instantiation of an instance of a rights bound token comprising a tokenized asset on a blockchain inextricably bound to the at least one rights package via at least the primary external binding has previously been discussed, and such discussion is not repeated in the interest of brevity.

Optionally at 1110, the system detects when the tokenized asset has been minted and wherein instantiating the at least one rights package on the same or a different blockchain from the tokenized asset as at least one immutable rights package is responsive to detection of the tokenized asset having been minted. As previously explained, the system can include blockchain listeners 810 (FIG. 8) which can listen for activity one various blockchain services, for example listening for the minting of a token that can be employed as an asset delivery vehicle or token in generating an RBT.

At 1112, the system instantiates the at least one rights package on the same or a different blockchain from the tokenized asset as at least one immutable rights package either synchronously with a minting of the tokenized asset or following the minting of the tokenized asset. The rights package can be instantiated on a blockchain in similar fashion to instantiating other types of files or objects on a blockchain, and the precise acts can be specific to the particular blockchain service.

The method 1100 can terminate at 1112, for example until or invoked again. Alternatively, the method 1100 can run continuously or periodically, for example as a continuous thread of a multi-threaded process. For example method 1100 can repeat to instantiate instances of rights bound tokens and instances of rights packages based on various sets of criteria.

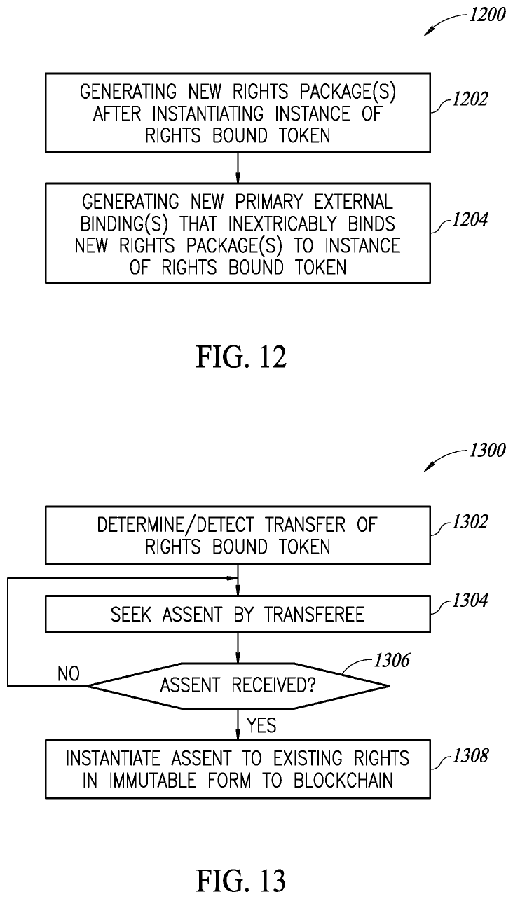

FIG. 12 shows a method 1200 of operation of a rights bound token creation and management system, which can for example be implemented as a rights bound token sever, according to at least one illustrated implementation. The method 1200 can, for example, be executed following the method 1100 (FIG. 11). The method 1200 can be executed by the system of any of the implementations illustrated or described herein, for example executed by the systems of any of the implementations illustrated or described herein, for example by the rights bound token sever 100 (FIG. 1), processor-based system 200 (FIG. 2), or rights bound token creation and management engine 700 (FIG. 7).

The method 1200 generates new rights package(s) after instantiating an instance of an RBT and generates a new primary external binding to bind the new rights package to the instance of the RBT. This advantageously allows for modifications to the rights to occur after instantiation of the RBT, for instance allowing additional rights to be extended. In executing or performing the method 1100, a system can, for example, employ one or more acts of the method 1000 (FIG. 10).

At 1202, generates at least one new rights package after instantiating an instance of a rights bound token. The at least one new rights package can include a new set of rights or a modification of existing rights. The at least one new rights package can, for example, include an indication of an assent by a new owner to a set of existing rights set out in the at least one rights package that was inextricably bound with the tokenized asset (e.g., asset delivery vehicle) via at least the primary external binding on the instantiation of the instance of an RBT.

At 1204, generates at least one new primary external binding that inextricably binds the at least one new rights package to the instance of the rights bound token. The generation of a primary external binding has previously been discussed, and such discussion is not repeated in the interest of brevity.

The method 1200 can terminate, at least until invoked again.

FIG. 13 shows a method 1300 of operation of a rights bound token creation and management system, which can for example be implemented as a rights bound token sever, according to at least one illustrated implementation. The method 1300 can, for example, be executed following the method 1100 (FIG. 11). The method 1300 can be executed by the systems of any of the implementations illustrated or described herein, for example by the rights bound token sever 100 (FIG. 1), processor-based system 200 (FIG. 2), or rights bound token creation and management engine 700 (FIG. 7).

The method 1300 addresses the transfer of a rights bound token, for example seeking assent by the transferee to existing rights. This advantageously allows for transfers after instantiation of the RBT. In executing or performing the method 1100, a system can, for example, employ one or more acts of the method 1000 (FIG. 10).

At 1302, the system determines or detects a transfer of the rights bound token. For example, the system can employ blockchain listeners 810 an/or blockchain triggers 812 (FIG. 8) to detect an occurrence of a transfer of an instance of an RBT.

At 1304, in response to a determination or detection of a transfer of the rights bound token, the system seeks an assent to existing rights by a transferee. For example, the system can query a transferee, for instance via the notifications module 814 (FIG. 8) of via some other query module or function. The query can provide an indication of the particular existing rights which the transferee is being asked to acknowledge and/or accept.

At 1306, the system determines whether an assent by the transferee has been received. If an assent has not been received, control can return to 1304 to query again for assent. Such can repeat until an exit condition occurs. If an assent has been received, control passes to 1308.

At 1308, in response to receiving the assent, the system instantiates the assent by the transferee to the existing rights in an immutable form to a blockchain.

The method 1300 can then terminate, at least until invoked again.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for exemplary purposes only and may change in alternative examples. Some of the exemplary acts or operations of the above described method(s), process(es), or technique(s) are performed iteratively. Some acts of the above described method(s), process(es), or technique(s) can be performed during each iteration, after a plurality of iterations, or at the end of all the iterations.

In some implementations, a single component (e.g., display, projector) can generate both the visual effects and the images, although typically one or more dedicated components (e.g., display, projector) will generate the visual effects while one or more dedicated components (e.g., display, projector) will generate the images, if any. Likewise, in some implementations, a single component (e.g., window, lens other optics) can present both the visual effects and the images, although typically one or more dedicated components (e.g., window, lens other optics) will present the visual effects while one or more dedicated components (e.g., window, lens other optics) will present the images, if any.

The teachings of U.S. patent application 63/402,197, filed Aug. 30, 2022, are incorporated by reference herein in its entirety.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. (canceled)

3. (canceled)

3. The method of claim 26 wherein selecting a rights manifest type includes selecting a rights manifest type that allows the rights manifest to be stored in an immutable, distributed and permanent form, on-chain or off-chain.

4. The method of claim 26 wherein selecting a binding type includes selecting at least one external binding type, and instantiating an instance of a rights bound token comprising a tokenized asset on a blockchain inextricably bound to the at least one rights package includes instantiating the instance of the rights bound token with at least one on-chain external binding of the selected external binding type, the at least one on-chain external binding which binds the tokenized asset and the rights package.

5. (canceled)

6. The method of claim 4 wherein instantiating the instance of the rights bound token with at least one on-chain external binding of the selected external binding type at least one on-chain external binding which binds the tokenized asset and the rights package includes instantiating the instance of the rights bound token with at least one on-chain external binding that is processed by a blockchain specific smart contract.

7. The method of claim 26 wherein instantiating an instance of a rights bound token comprises instantiating the instance of the rights bound token that is either fungible or non-fungible.

8. The method of claim 26 wherein instantiating an instance of a rights bound token comprises instantiating the instance of the rights bound token where an owner of the instance of the rights bound token is an owner of a blockchain wallet address that holds the instance of the rights bound token.

9. The method of claim 26 wherein instantiating an instance of a rights bound token comprises instantiating the instance of the rights bound token where a transfer of the instance of the rights bound token conveys a set of rights to a transferee in an asset beyond the rights bound token itself, and ownership of the instance of the rights bound token is definitively discernable at all points in time.

10. (canceled)

11. The method of claim 26 wherein instantiating an instance of a rights bound token comprises instantiating the instance of the rights bound token that has at least one rights package that specifies multiple rights associated to the instance of the rights bound token.

12. (canceled)

13. The method of claim 26 wherein instantiating an instance of a rights bound token comprises instantiating the instance of the rights bound token in which the rights package of the instance of the rights bound token specifies at least one right that changes over time, where the at least right is definitively discernable at all points in time and wherein generating the at least one rights package occurs prior to minting the tokenized asset.

14. The method of claim 26 wherein instantiating an instance of a rights bound token comprises instantiating the instance of the rights bound token in which the rights package of the instance of the rights bound token specifies at least one right that is associated with a smart contract.

15. The method of claim 26 wherein generating at least one rights package based on at least one set of criteria includes generating at least one rights package that specifies a set of rights in an asset beyond the rights bound token itself, the rights including one or more of: a right in tangible property, right in real property, a right in intellectual property, a right to usage of an asset, or an easement right.

16. The method of claim 26 wherein generating at least one rights package based on at least one set of criteria includes generating at least one immutable rights package.

17. The method of claim 26 wherein generating the at least one rights package occurs prior to the instantiating the instance of the rights bound token comprising the tokenized asset on the blockchain inextricably bound to the at least one rights package or occurs subsequent to the instantiating the instance of the rights bound token comprising the tokenized asset on the blockchain inextricably bound to the at least one rights package.

18. (canceled)

19. The method of claim 26 wherein instantiating an instance of a rights bound token comprising a tokenized asset on a blockchain inextricably bound to the at least one rights package includes instantiating the instance of the rights bound token comprising the tokenized asset on the blockchain inextricably bound to the at least one rights package via a primary external binding when the tokenized asset is minted, wherein the primary external binding is a cryptographic two way binding.

20. (canceled)

21. The method of claim 19 wherein the bindings include one or more additional bindings in addition to the primary external binding, and further comprising:
generating one or more additional bindings before instantiating the instance of the rights bound token, and wherein generating one or more additional bindings before instantiating the instance of the rights bound token includes generating one or more additional internal bindings before instantiating the instance of the rights bound token.

22-25. (canceled)

26. A method executed via at least one processor and at least one nontransitory processor-readable medium communicatively coupled to the at least one processor, comprising:
generating at least one rights package customized to a specific application or user, the at least one rights package specifying at least one right that is based on at least one set of criteria;
selecting a binding type to be used as a primary external binding;
subsequent to the generating of the at least one rights package, instantiating by the at least one processor an instance of a rights bound token comprising a tokenized asset on a blockchain inextricably bound to the at least one rights package via at least the primary external binding; and
instantiating by the at least one processor the at least one rights package on a same blockchain or a different blockchain from the tokenized asset as at least one immutable rights package either synchronously with a minting of the tokenized asset or following the minting of the tokenized asset.

27. The method of claim 26, further comprising:
selecting a rights protocol;
selecting a rights manifest type;
generating a rights manifest based at least in part on the selected rights manifest type; and
selecting a rights storage type,
wherein generating at least one rights package includes generating the rights package comprising the rights manifest and the rights storage.

28. The method of claim 26, further comprising:
detecting by the at least one processor when the tokenized asset has been minted and wherein instantiating the at least one rights package on the same or a different blockchain from the tokenized asset as at least one immutable rights package is responsive to detection of the tokenized asset having been minted.

29. The method of claim 26, further comprising:
generating at least one new rights package after instantiating an instance of a rights bound token, wherein the at least one new rights package includes a new set of rights; and
generating at least one new primary external binding that inextricably binds the at least one new rights package to the instance of the rights bound token.

30. (canceled)

31. The method of claim 26 wherein the at least one rights package includes an indication of an assent by a new owner to a set of existing rights set out in the at least one rights package that was inextricably bound with the tokenized asset via at least the primary external binding on the instantiation of the instance of a rights bound token.

32. The method of claim 26, further comprising:
in response to a transfer of the rights bound token, seeking an assent to existing rights by a transferee; and
instantiating by the at least one processor the assent by the transferee to the existing rights in an immutable form to a blockchain.

33-67. (canceled)
